(19) United States
(12) Patent Application Publication
(10) Pub. No.: US 2010/0210217 A1
(43) Pub. Date: Aug. 19, 2010

(54) WIRELESS COMMUNICATIONS SYSTEM IN AN AIRPLANE

(75) Inventors: Stefan Marten, Wedemark (DE); Christian Grone, Neustadt (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co. KG, Wedemark (DE)

(21) Appl. No.: 12/707,823

(22) Filed: Feb. 18, 2010

(30) Foreign Application Priority Data
Feb. 18, 2009 (DE) 10 2009 009 388.5

(51) Int. Cl. H04B 7/00

(52) U.S. Cl. 455/66.1

(57) ABSTRACT

There is provided a wireless communication system in an aircraft. The system has at least one wireless headset (100) having a first wireless transmitter/receiver and a cockpit (200). The cockpit (200) has a second wireless transmitter/receiver (230) for wireless communication with the at least one wireless headset (100).

The present invention concerns a wireless communication system in an aircraft.

Typically wireless communication systems such as for example the use of a cellular telephone are prohibited in an aircraft as such a wireless communication can interfere with what is referred to as intercom communication, that is to say wireless communication with a tower, or with operation of the aircraft.

U.S. Pat. No. 2005/0260953 A1 describes a wireless communication system for use in an aircraft. For that purpose the system provides a battery-operated wireless headset as well as a control unit having a transmitter and a receiver. The control unit is connected to the communication system of the aircraft by means of a cable and corresponding plug to permit wireless communication with the wireless headset.

U.S. Pat. No. 2007/0287447 A1 in contrast describes a wireless communication system in an aircraft. For that purpose the system has a wireless headset for transmitting and receiving communication signals. In addition there is provided a transceiver having a plug, wherein that plug can be inserted into an existing aircraft communication system so that the hitherto wired communication can be effected wirelessly by means of the transceiver. In other words an additional unit has to be fitted into the jack provided for the headset in the cockpit. Accordingly this proposes an addition to an existing communication system to permit wireless communication within an aircraft.

The transceiver can have a back-up power supply. The wireless headset can have a circuit for displaying a failed communication, that is to say a display is provided in the wireless headset if the communication channel is not present or is not of adequate quality. In addition a unit for displaying a low battery voltage can be provided in the wireless headset. The members of a crew can also communicate wirelessly with each other within the aircraft by the described wireless communication system.

An object of the present invention is to provide a wireless communication system in an aircraft, which permits a more flexible configuration.

That object is attained by a wireless communication system in an aircraft as set forth in claim 1.

Thus there is provided a wireless communication system in an aircraft. The system has at least one wireless headset having a first wireless transmitter/receiver and a cockpit. The cockpit has a second wireless transmitter/receiver for wireless communication with the at least one wireless headset.

In accordance with an aspect of the present invention the cockpit has an intercommunication unit for wireless communication with a tower and/or other aircraft. The intercommunication unit is coupled to the second wireless transmitter/receiver so that the second wireless transmitter/receiver can wirelessly transmit the signals received from the intercommunication unit to the wireless headset.

In accordance with a further aspect of the present invention the second wireless transmitter/receiver is fixedly installed in the cockpit.

In accordance with a further aspect of the present invention the wireless headset monitors the wireless communication and communicates items of status information in the wireless signal to the cockpit for evaluation.

In accordance with a further aspect of the present invention the second wireless transmitter/receiver is adapted to receive the transmitted items of status information. Evaluation of the items of status information is effected and optionally an optical and/or acoustic warning signal is produced.

In accordance with a further aspect of the present invention the cockpit has at least one audio input to which a cellular telephone and/or a media player can be connected. The audio signals transmitted by the cellular telephone or the media player are wirelessly transmitted to the headset by means of the second wireless transmitter/receiver.

In accordance with a further aspect of the present invention the cockpit has an auxiliary input. The headset has a further input, by way of which a wired communication is possible by way of the auxiliary input of the cockpit.

In accordance with a further aspect of the present invention the wirelessly transmitted signal is encrypted.

In accordance with a further aspect of the invention the cockpit has a battery output and the wireless headset has a battery charging input so that the battery unit in the wireless headset can be charged up by way of a charging cable.

Further configurations of the invention are subject-matter of the appendant claims.

Advantages and embodiments by way of example of the invention are described in greater detail hereinafter with reference to the drawing.

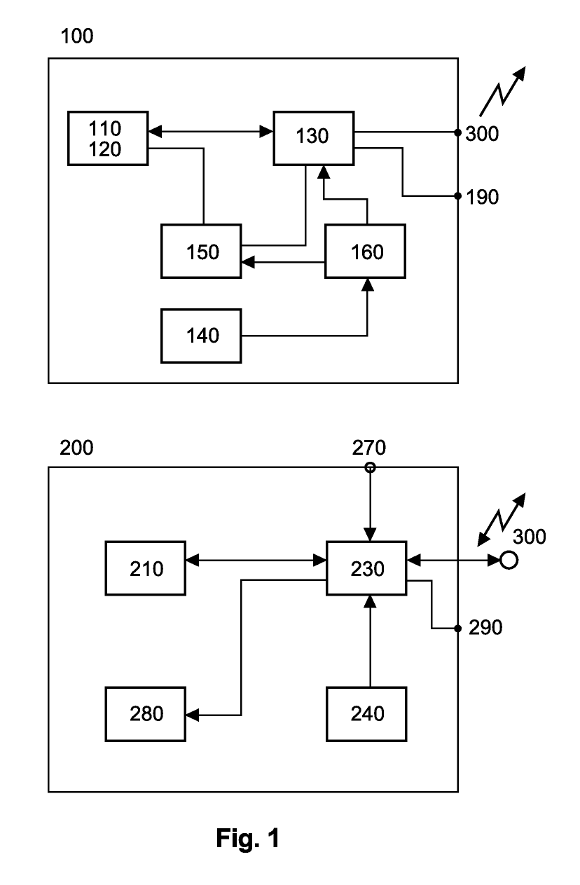

FIG. 1 shows a schematic block circuit diagram of a wireless communication system according to the invention.

FIG. 1 shows a schematic block circuit diagram of a wireless communication system according to the invention. The wireless communication system according to the invention is implemented in an aircraft. For that purpose there is provided a cockpit 200 having a wireless transmitter/receiver and at least one wireless headset 100 or wireless earphone. The cockpit 200 is however also adapted to communicate with a plurality of wireless headsets 100.

The wireless headset 100 has at least one (preferably two) electroacoustic reproduction transducers 110, a speech microphone 120 and a wireless transmitting/receiving unit 130. The wireless headset 100 can also optionally have a control unit 160 and an active noise reduction unit 150. The wireless headset further has a battery unit 140 serving to provide the power required for operation of the wireless headset 100.

The speech signals recorded by the microphone 120 can be transmitted wirelessly by means of the transmitting/receiving unit 130. In addition wirelessly transmitted audio signals can be received by the transmitting/receiving unit 130 and reproduced by the electroacoustic reproduction transducers 110. Optionally in that case active noise reduction can be effected by the active noise reduction unit 150. The battery unit 140 outputs the actual charge condition to the control unit 160 or to the transmitting/receiving 130 respectively. Those items of information are then transmitted wirelessly by means of the transmitting/receiving unit 130 in the transmitted signal 300, as items of status information 330. The transmitting/receiving unit 130 detects the reception quality of the wireless communication and communicates that reception quality within the items of status information 330. The wireless signal 300 optionally has an intercom signal 310, external audio signals 320 and items of status information.

The cockpit 200 has a wireless transmitting/receiving unit 230 for the wireless reception of signals 300 from the headset 100. The voltage supply 240 is preferably coupled to the voltage supply of the aircraft. The cockpit can further have an intercom unit 210 for wireless communication for example with a tower or other aircraft. The transmitting/receiving unit 230 is coupled to the intercom unit 210 so that communication can be wirelessly transmitted by way of the intercom unit 210 within the wireless signal 300 as an intercom signal 310 to the wireless headset 100.

Optionally the cockpit 200 can have a warning unit 280 which evaluates the items of status information 330 from the wireless signal 300 and outputs an optical and/or acoustic warning if for example the battery charge condition falls below a threshold value or if the reception quality falls below a predetermined threshold value.

The cockpit can further have an audio input 270 to which a cellular telephone and/or a media player can be connected. The signals received by that audio input 270 are wirelessly transmitted by the transmitting/receiving unit 230 to the wireless headsets 100 where they can then be reproduced by the electroacoustic reproduction transducers 110.

Optionally the headset 110 can be adapted to monitor the battery charge condition and/or the reception quality of the wireless transmission and, when those parameters fall below given threshold values, output an optical and/or acoustic warning signal.

Furthermore the wireless headset 100 can be adapted to switch off parts of the headset such as for example active noise reduction of the wireless headset to save power, upon the detection of a low charge condition of the battery unit.

The wireless connection between the cockpit and the wireless headset 100 can be effected based on Bluetooth, WLAN, infrared or the like. The wireless connection between the wireless headset and the cockpit 200 is continuously maintained to ensure that no information is lost. Checking of the wireless communication can be effected at regular or irregular intervals, in which case an optical and/or acoustic warning signal can be produced if the wireless communication is disturbed.

Optionally the wireless communication can be encrypted.

The headset 100 can have an input 190 to which a cable can be connected, for example if the battery unit 140 is empty or if the wireless communication is disturbed. In such a case the wireless headset 100 can communicate by wire with the cockpit. For that purpose the cockpit can have an auxiliary input 290 to which the other end of the cable can be connected.

Optionally the cockpit 200 can have a battery output to which a first end of a charging cable can be connected. The second end of the charging cable can be connected to a charging input of the wireless earphone so that charging of the battery unit 140 can also be effected while in operation.

Preferably the replacement cable and the charging cable can be stowed in or at the cockpit 200.

The wireless communication between the cockpit 200 and the headset 100 can be controlled for example by the cockpit. In that respect it is possible to determine for example the choice of channel, support for external audio sources and the behaviour in the case of an empty battery unit.

Optionally the wireless transmitter/receiver 230 can be provided in a housing with the intercom unit 210.

The transmitting/receiving unit 230 can be provided in the cockpit 200 and can thus represent a fixedly installed component part of the cockpit. Thus the jack 290 in the cockpit is not required for connection of the transmitting/receiving unit 230.

1. A wireless communication system in an aircraft comprising
at least one wireless headset having a first wireless transmitter/receiver, and
a cockpit which has a second wireless transmitter/receiver for wireless communication with the at least one wireless headset.

2. A communication system as set forth in claim 1 wherein the cockpit has an intercommunication unit for wireless communication with a tower and/or other aircraft, wherein the intercommunication unit is coupled to the second wireless transmitter/receiver so that the second wireless transmitter/receiver wirelessly communicates the signals received from the intercommunication unit to the wireless headset.

3. A communication system as set forth in claim 1 wherein the second wireless transmitter/receiver is fixedly installed in the cockpit.

4. A communication system as set forth in claim 1 wherein the wireless headset monitors the wireless communication and communicates items of status information in the wireless signal to the cockpit for evaluation.

5. A communication system as set forth in claim 1 wherein the second wireless transmitter/receiver receives the transmitted items of status information, wherein evaluation of the items of status information is effected and optionally an optical and/or acoustic warning signal is produced.

6. A communication system as set forth in claim 1 wherein the cockpit has at least one audio input to which a cellular telephone and/or a media player can be connected, wherein the audio signals transmitted by the cellular telephone or the media player are wirelessly transmitted to the headset by means of the second wireless transmitter/receiver.

7. A communication system as set forth in claim 1 wherein the cockpit additionally has an auxiliary input and the wireless headset has a further input, by way of which a wired communication is possible.

8. A communication system as set forth in claim 1 wherein the wirelessly transmitted signal is encrypted.

9. A communication system as set forth in claim 1 wherein the cockpit has a battery output and the wireless headset has a charging input so that the battery unit can be charged up by way of a charging cable.

10. A communication system as set forth in claim 1 wherein the headset is adapted to monitor the battery charge condition and/or the reception quality of the wireless transmission and to output an optical and/or acoustic warning signal if the parameters fall below previously set threshold values.

11. A communication system as set forth in claim 10 wherein the headset has an active noise reduction unit for active noise reduction and is adapted to switch off the active noise reduction unit if the charge condition of the battery falls below a threshold value.

12. A communication system as set forth in claim 1 wherein the wireless communication between the wireless headset and the second wireless transmitter/receiver in the cockpit is constantly maintained to ensure that no items of information are lost.
